(19) United States
(12) Patent Application Publication
(10) Pub. No.: US 2005/0284801 A1
(43) Pub. Date: Dec. 29, 2005

(54) Suture bandage

(76) Inventor: Christopher A. Tacklind, Palo Alto, CA (US)

Correspondence Address: Chris Tacklind, 250 Cowper Street, Palo Alto, CA, 94301, US

(21) Appl. No.: 10/874,926

(22) Filed: Jun. 23, 2004

(51) Int. Cl. A01F 12/44

(52) U.S. Cl. 209/132

(57) ABSTRACT

A method and apparatus are presented for a microscopic valve. The valve is electronically activated. Sensors for detecting objects in the flow may be external or formed in the channels of the valve. Many valves can be formed in parallel and in sequence on a single substrate. Multiple channels may feed each junction. Closure of the valve is accomplished by the formation of a vapor bubble or bubbles. Virtual walls may be formed by a sequence of bubbles. Logic and driver circuitry for producing bubbles may be external or included in the substrate. Such an array is ideally suited for sorting cells. Other materials in a suspension may also be sorted by a variety of criteria. A multi lumen output can produce a continuous distribution of cells or particles thus sorted.

### BACKGROUND OF THE INVENTION

Bandages are commonly sheets used to protect a wound. These range from wrap-on gauze to self-adhesive patches. There is a considerable volume of art in the field of adhesive bandages. Often, they are flat panels with a gauze central area. Special shapes have been developed to address many specific needs.

A second use for bandages is to hold wounds closed or immobile. One type commonly known as “Butterfly Closures” is often used in lieu of sutures. These do not provide for drawing the sides of the wound together.

Sutures are capable of pulling a wound closed. They require perforating the skin along each side of a wound. This can only be performed by trained personnel.

### SUMMARY OF THE INVENTION

The invention at hand relates to a novel device for closing a wound without the use of sutures. Filaments are used to pull the sides of a wound closed. But the filaments do not perforate the skin as is the practice with sutures. Instead, a lower pair of self-adhesive strips is applied along both sides of the wound. Filaments emanate from the opposing edges of each strip, back across the wound. These are attached to an upper pair of self-adhesive strips. Drawing the upper pair of strips apart pulls the edges of the wound closed. An adhesive backing secures the upper patches down substantially upon the lower patches. The wound is thus held closed.

Unlike sutures, unskilled users can readily accomplish the operations described. The length of the filaments and the width and length of the strips are readily selected to accommodate many applications. Long and or wide strips are easily cut to size as needed.

### BRIEF DESCRIPTION OF THE DRAWINGS

FIG. 1 shows an oblique view of one embodiment of a Suture Bandage before use with release liners in place.

FIG. 2 shows a Suture Bandage in an exploded sectional view with exaggerated thickness.

FIG. 3 shows a cross section of a Suture Bandage with a first pair of strips adhered to the skin on opposite sides of an open wound.

FIG. 4 shows a cross section of a Suture Bandage with a second pair of strips adhered to the skin on opposite sides of a closed wound.

FIG. 5 is an oblique view of an applied suture bandage with the second pair of strips attached substantially upon the first pair of strips.

FIG. 6 shows an alternative arrangement for release liners.

FIG. 7 is an oblique view of an embodiment with a single filament.

FIG. 8 is an oblique view of a pair of single filament Suture Bandages used to close a wound.

FIG. 9 is an oblique view of an alternate embodiment with suture loops laced like a shoe.

FIG. 10 shows an alternate arrangement with dual layer patches and zigzag filiments.

FIG. 11 shows top pads repositioned pulling zigzag filaments closing a wound.

### DETAILED DESCRIPTION OF THE INVENTION

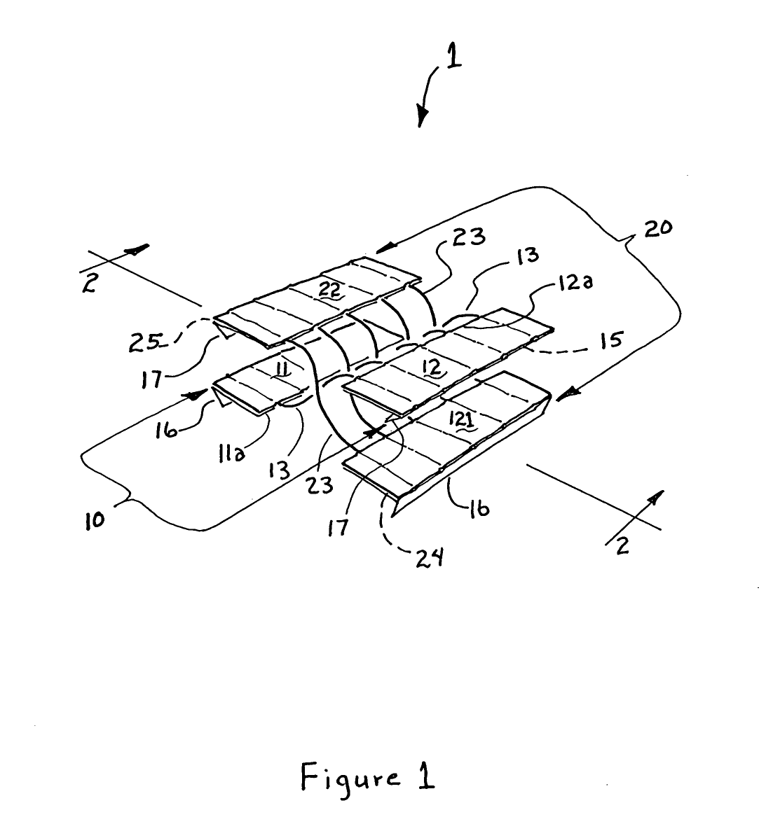

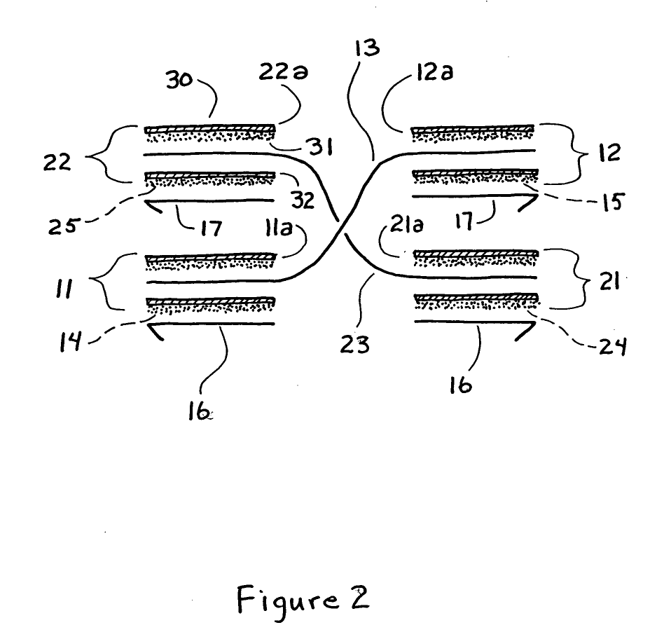

FIGS. 1 and 2 show the general configuration of one embodiment of the suture bandage 1 of the invention. It is shown ready for use but not applied to a patient. FIG. 1 is an oblique perspective view of the suture bandage 1. FIG. 2 is an end-on, exploded cross-sectional view of the suture bandage 1, as viewed along line 2-2 in FIG. 1. FIG. 2 is shown expanded in the vertical dimension to more clearly illustrate the arrangement of the elements.

As best seen in FIG. 1, the suture bandage 1 comprises two linked, spaced-apart, interlaced sets 10 and 20 of adhesive patches and filaments.

The first set 10 of adhesive patches includes spaced-apart adhesive patches 11 and 12 linked by a plurality of filaments or tensile bands 13. The filaments may be stiff, or stiff in tension and otherwise flexible or may be elastic. In the example shown, the patches 11 and 12 are of generally rectangular shape, but the patches need not be rectangular. The patches 11 and 12 are disposed with the longitudinal axis of rectangular patch 11 lying generally parallel to the longitudinal axis of the opposed patch 12. Each of the filaments 13 are mounted or fixed at one end to patch 11 adjacent longitudinal patch edge 11a, and each filament 13 is fixed at the other end to patch 12 adjacent the opposing patch edge 12a. The points of mounting of the plurality of filaments 13 are spaced at intervals along each of patch edges 11a and 12a, distributed along all or part of the patch edges 11a and 12a. Thus, each filament 13 spans between and links the opposed patches 11, and 12 of the set 10, the filaments lying in generally parallel alignment with one another. Each adhesive patch 11, and 12 have a skin-compatible adhesive coating 14, 15, respectively, on the lower patch surface. The adhesive coatings 14, 15 are preferably covered with a protective release liners 16, 17, respectively, until it is to be applied to a patient.

The second set 20 of adhesive patches is substantially identical in general configuration to the first set of patches 10. The second set 20 or adhesive patches includes spaced-apart patches 21 and 22 linked by a plurality of filaments 23, the patches 21 and 22 being disposed with patch 21 lying generally parallel to the opposed patch 22. Each of the filaments 23 are fixed at one end to patch 21 adjacent edge 21a, and at the other end to patch 22 adjacent the opposing edge 22a. The filaments 23 thus span in generally parallel alignment between opposed patches 21 and 22 of the pair 20. Each patch 21, 22 has an adhesive coating 24, 25, respectively, on its lower surface, covered with a release liner 16, 17, respectively.

As also seen in FIG. 2, the filaments 13 of patch set 10 are interlaced in an overall “X” configuration with the filaments 23 of patch set 20, so that in the views of FIGS. 1 and 2, patch 11 is disposed underneath patch 22; and patch 21 is disposed beneath patch 12. In other words, the filaments 23 extend from patch 21 to intersect in offset arrangement the “plane” of the filaments 13, so as to pass through this “plane” to extend to the fixing points of the filaments 23 on patch 22. This interlaced configuration of the filaments 13 and 23 creates a sliding, adjustable interweaving between the two respective patch sets 10 and 20.

FIG. 1 shows an oblique view of bandage 10 before use. The multiple filaments 13, and 23 are generally flexible and so the configuration shown is staged to better identify the arrangement of the components. Multiple release liners 15 and 25 are shown in place so as to protect the adhesive layers. This is the complete configuration as it is removed from a sterile pouch or cut from a roll.

The width of the patches may be manufactured in any width suitable for the application. If the width supplied is too wide it is readily trimmed to width with scissors. Alternative embodiments having special shapes are readily manufactured to promote adhesion, installation, conforming to a contour, or removal.

The length of the pads may also be manufactured to suit the application. If it is too long for a particular wound, it is readily cut shorter. A roll of Suture Bandage may also be manufactured and then cut to length as needed.

FIG. 2 shows one example of the construction of a Suture Bandage in an exploded sectional view with exaggerated thickness. Each patch 11, 12, 21, 22, is composed of several components which are described for patch 22 by way of example. At the top of the patch is a membrane 30. This may be a woven fabric or flexible plastic as is common in other bandages and tapes. This membrane may have ventilating holes. In one embodiment, an adhesive layer 31 is bound to the membrane. This adhesive is used to adhere the filaments 23 to the top of a second membrane 32. Other means may be employed to build the patch such as heat sealing or ultrasonic welding or radio frequency welding. Membrane 32 has a pressure-sensitive skin adhesive layer 25 on its underside. This last adhesive layer is protected during shipment by release liner 17.

The filaments may be formed from the membrane material instead of a separate part. The filaments are woven past each other in the manufacturing process. Multiple small patches may replace the two upper patches 12, 22.

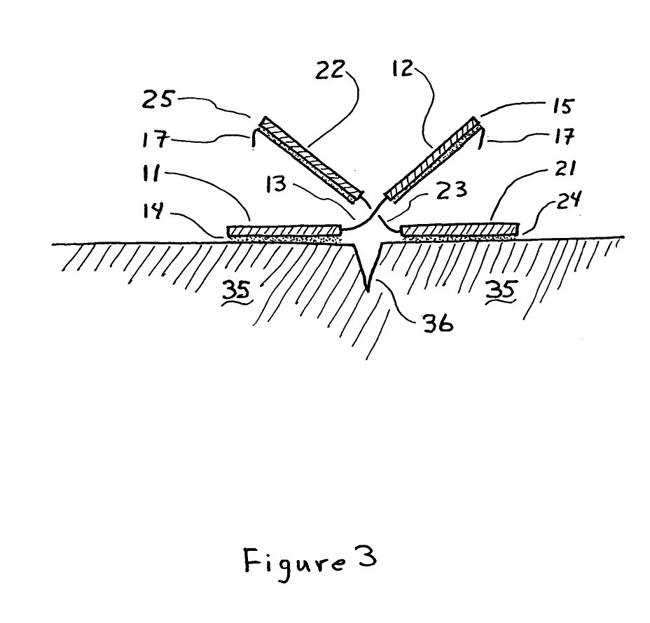

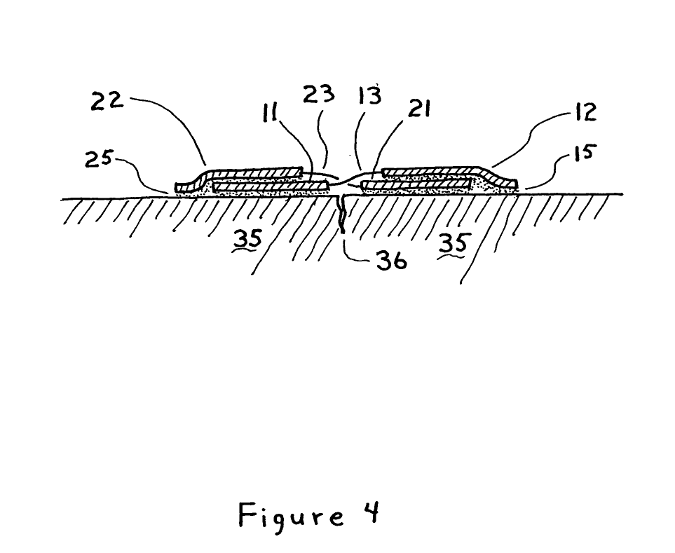

FIGS. 3 and 4 show the sequence of applying the bandage 1 to a wound 36. FIG. 3 shows a cross section of the bandage with the bottom pair of patches adhered to the skin 35 on opposite sides of an open wound 36. In a conventional suture the filaments would be sewn to the skin on opposite sides of the wound. The lower patches 11, 21 of the invention provide this attachment. This is readily accomplished by an unskilled user or on ones self. The upper patch release liners 16 are shown still in place.

To complete the installation, the upper release liners 16 are removed and the upper patches 12, and 22 are drawn apart across the wound. This pulls all of the filaments simultaneously drawing upon the edges of the lower patches 11, and 21. This exerts a shear force on the strips, rather than a peeling force, on the adhesive bond so the lower patches 11, and 21 hold fast to the skin. The wound is thus drawn closed by the filaments 13, 23.

Since all filaments are pulled simultaneously, the stress concentrations are greatly reduced. This eliminates the formation of penetration blemishes on the skin. The pads can be freely adjusted during installation aligning the sides of the wound accurately. If need be, the pads can be removed and repositioned. This is particularly important where cosmetic appearance of the resulting scar is important.

FIG. 4 shows a cross section of the bandage with the upper pair of patches 12, and 22 adhered to the skin 35 on opposite sides of the wound 36. This holds the wound closed. The upper patches are shown substantially adhered upon the lower patches. This relative position will vary depending upon the initial placement of the lower patches, the filament length and the wound opening.

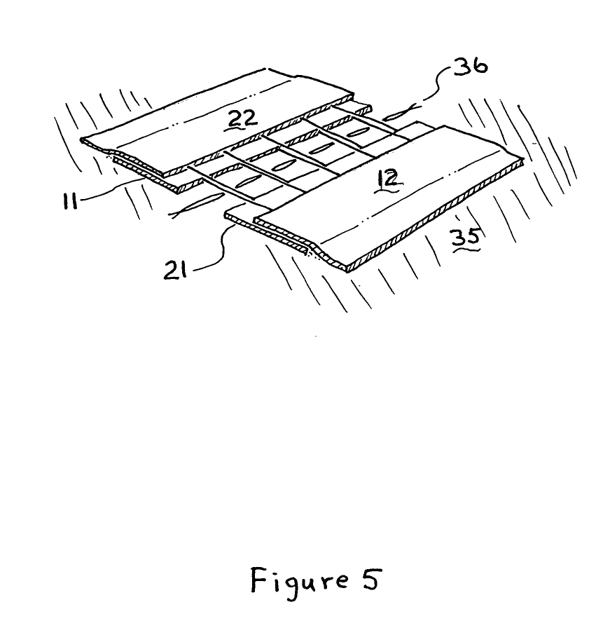

FIG. 5 is an oblique view of an applied bandage with the second pair of strips substantially upon the first pair of strips. The arrangement of filaments leaves the wound open to the air. This allows for the application of topical medicine. Medications may be included in the patches and or filaments. The filaments may be of a non-stick material or have a non-stick coating. A protective covering bandage may be adhered over the wound and patches. The outer surface of the upper patch may have a non-stick surface to promote cleaning and prevent peeling by an outer covering. The outer covering may be changed as needed without disturbing the suture bandage.

The patches may be flexible, so that the wound is allowed flexibility while maintaining the closure. Stiff patches or stiffening elements in the patches can supply more rigidity to the site as needed for the application.

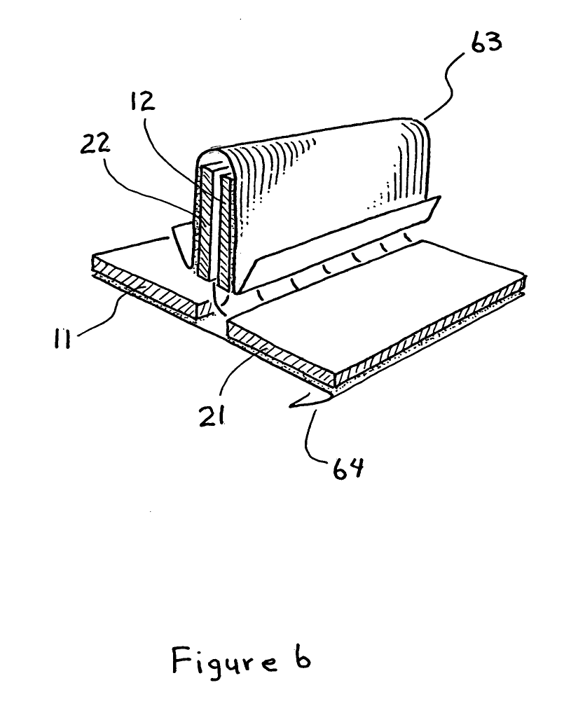

FIG. 6 shows an alternative arrangement for the release liners. Upper release liners, 17, have been replaced by a single folded liner 63. The Lower release liners, 16 have been replaced by a single flat liner, 64. In practice this configuration is convenient for handling and adds in the clarity of the application steps. Alternative configurations may be employed which are convenient for the end user or manufacturer. Tabs may be included on the liners to help the installation.

In the installation described the patches are only subjected to shear forces by the filaments. So the patches stay firmly in place as long as needed. When the suture bandage needs to be removed, the edges are readily peeled up. There is no need for professional removal. So there is no need to return to a medical practitioner for the traditional removal of stitches.

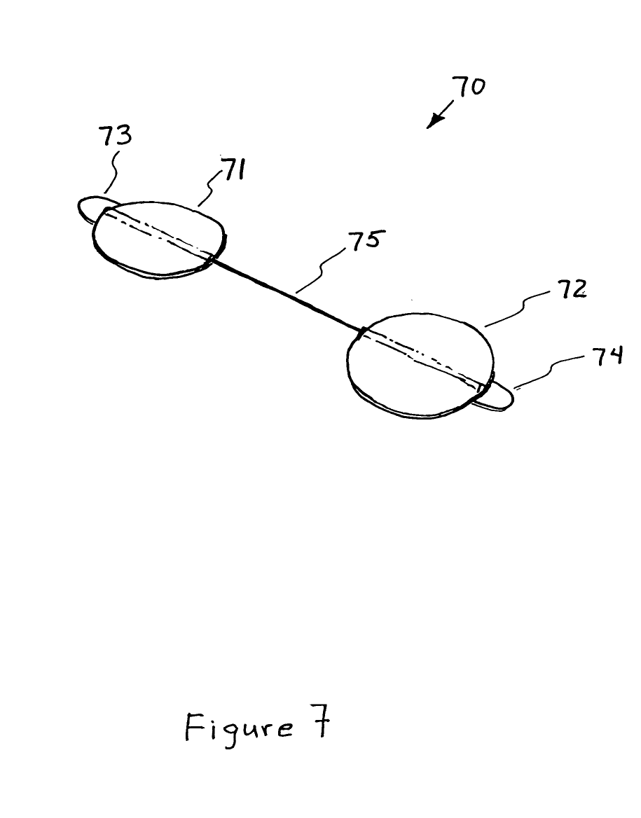

Simpler arrangements are also valuable. FIG. 7 is an oblique view of a Single Filament Suture Bandage, 70. This embodiment has two patches 71, and 72 connected by a single filament 75. Release liners, 73 and 74 are provided to protect the adhesive surface. A single filament is similar to the prior art and cannot provide a closing action. A pair of Single Filament Suture Bandages are used together. One end of each is attached on either side of the wound. Then the second patches are pulled apart, drawing the wound closed. The second patches are adhered generally over the first patches.

A hybrid between a Multiple Filament Suture Bandage and a Single Filament Suture Bandage is possible. In one embodiment, Two strips are affixed on opposing sides of a wound. Multiple filaments emanate from the interior edges. The end of each filament is terminated with a separate patch. This simplifies manufacturing since inter weaving of the filaments is not necessary.

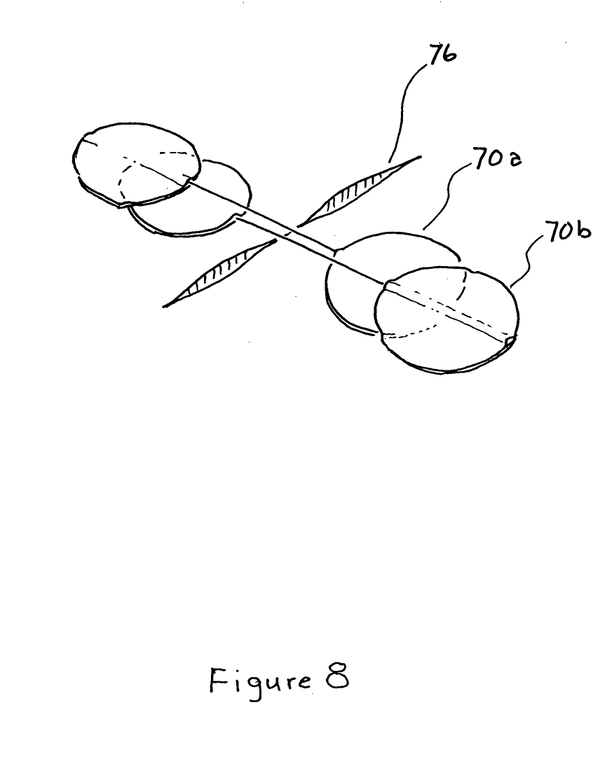

FIG. 8 is an oblique view of a pair of Single Filament Suture Bandages, 70a and 70b, positioned closing a wound, 76. Multiple pairs may be used to close a larger wound. Other pairs could be used in a radial pattern to close a puncture wound. The filament could be formed from the same material as the Adhesive Patch.

An alternately configured embodiment of the suture bandage is to adhere patches with loops along opposing edges. Then filaments may be sewn between the loops drawing the wound closed in the manner of a shoelace.

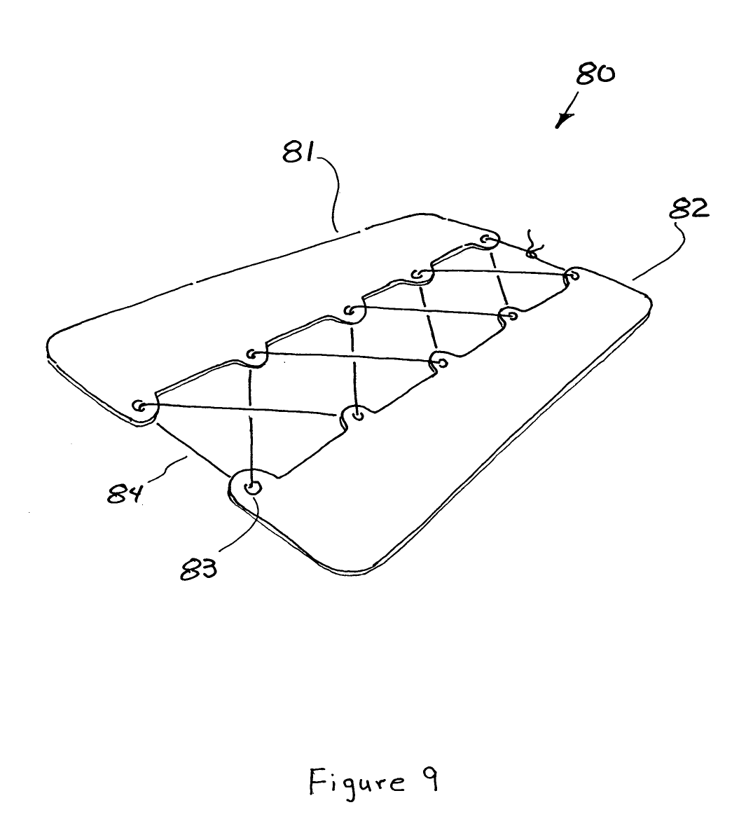

FIG. 9 is an oblique view of such an alternate embodiment with suture loops 83 along one edge of each patch, 81 and 82. The two patches are then laced together like a shoe. Tightening the filament, 84 draws the wound closed. This completes the Suture Bandage assembly 80. The loops may be formed in the patch material. Alternately the loops may be a separate plastic or metal part connected to the adhesive patches. The loops may be open hooks to facilitate lacing. In this case a single or double filament can be laced up the hooks like a boot with quick lace hooks. The filament may be removed and repositioned as needed. This assembly offers additional flexibility as the filament may be allowed to slide in the suture loops. The sutures in this application are quickly removed by cutting a single pass of the filament.

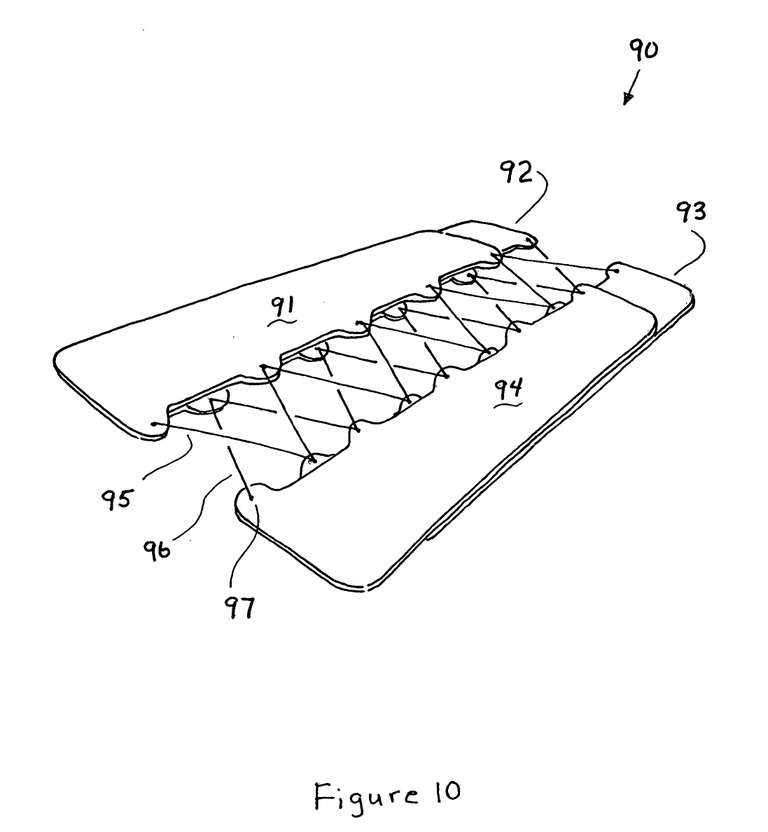

FIG. 10 shows an alternative arrangement of filaments, 95 and 96 assembled in a zigzag pattern. The filaments are actually sewn into tabs 97 of lower pads 92 and 93 and upper pads 91 and 94. Notice that the filament 95 attaches the upper pad 91 to the lower pad 93. Respectively, the filament 96 attaches the upper patch 94 to the lower patch 92. Release liners are not shown.

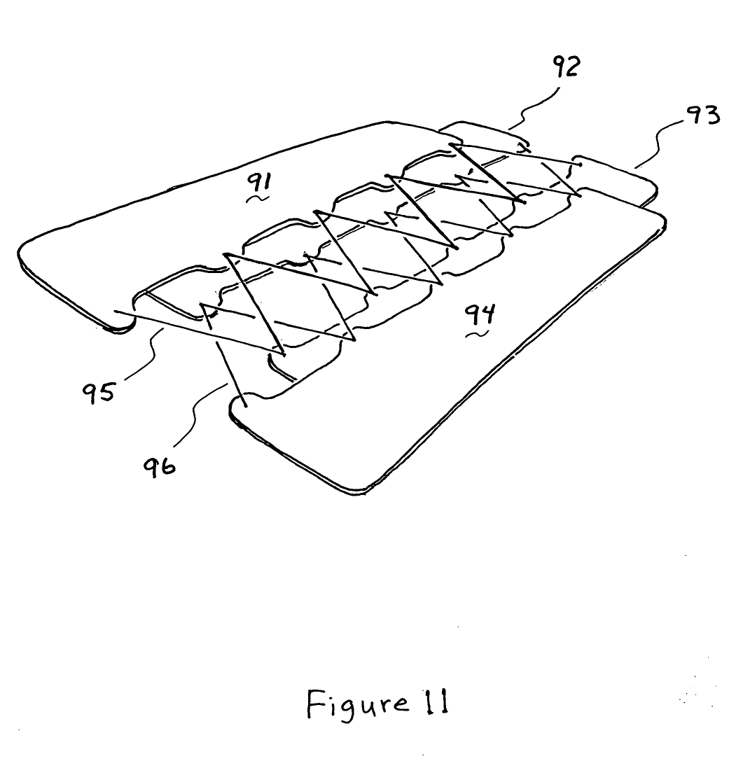

The assembly, 90 is placed over the open wound in the configuration as shown in FIG. 10. The upper pads 91 and 94 are then peeled up. Pulling the upper pads outwards tightens the filaments 95, 96. This draws the wound closed. FIG. 11 shows top pads 91, 94 repositioned relative to the bottom pads 92, 93 pulling zigzag filaments 95, 96 closing the wound.

These examples clearly demonstrate the spirit of the invention. Further embodiments will be evident to one skilled in the art and are considered to be within the scope of this patent.

1. An apparatus for diverting the fluid flow from a channel to one of two channels by the formation of a vapor bubble.

2. A device for sorting cells and the like comprising:
a. one or more input channel(s)
b. a flow of suspended cells or particles,
c. two or more output channels,
d. a means for forming a vapor bubble occluding one or more of said output channels

3. a device as in claim 1 where said vapor bubble is formed by heat from a thin film resistor situated in said channels

4. a device as in claim 1 with a detection means for said cell

5. a device as in claim 4 where said cells are marked with a florescent dye

6. a device as in claim 5 where said detection means is a photo detector

7. a device as in claim 5 with control circuitry detecting signals from said photo detector(s) and drivers for said resistors.

8. A device for sorting cells and the like comprising:
a. one or more input channel(s),
b. two or more output channels,
c. a means for forming a vapor bubble occluding one or more of said output channels and,
d. a thin film resistor with control circuitry in close proximity to said channels

9. a device as in claim 7 where said cells are marked with a florescent dye

10. a device as in claim 8 where a photon generating device is situated in said input channel

11. a device as in claim 8 where a photon detector is situated in said input channel

12. a device as in claim 10 where said control circuitry is triggered to form said vapor bubble in response to detected photons

13. a device as in claim 11 where said control circuitry receives command controls from a data bus

14. a device as in claim 11 where said detection signals are relayed out through a data bus.

15. A method for sorting cells and the like comprising:
a. causing a flow of a suspension of cells through an input channel
b. detecting a particle in said input channel,
c. deciding which output channel to direct said particle, and
d. forming a vapor bubble to restrict said flow to one or more channels.

16. a method as in claim 14 in which said particles are marked with a florescent dye.

17. a method as in claim 15 in which said florescent dye is exposed to light while in said channel.

18. a method as in claim 16 where the light emitted by said fluorescing dye is detected by a photo detector.

19. a method as in claim 17 in which the detection of said light triggers the formation of said vapor bubble in one or more said channel(s).

20. a method as in claim 18 in which multiple input channels are processed in parallel

21. a method as in claim 19 in which multiple output channels present particles sorted by multiple markers
